(19) United States
(12) Patent Application Publication
(10) Pub. No.: US 2025/0385290 A1
(43) Pub. Date: Dec. 18, 2025

(54) MANUFACTURING APPARATUS OF BATTERY CELL AND MANUFACTURING METHOD OF BATTERY CELL

(71) Applicant: SK ON CO., LTD., Seoul (KR)

(72) Inventors: Seung Won CHOI, Daejeon (KR); Jae Gyu BYUN, Daejeon (KR); Dong Hyeon OH, Daejeon (KR); Taek Eon JEONG, Daejeon (KR)

(21) Appl. No.: 19/221,510

(22) Filed: May 29, 2025

(30) Foreign Application Priority Data
Jun. 14, 2024 (KR) 10-2024-0077689

(51) Int. Cl. H01M 10/04; H01M 50/105

(52) U.S. Cl. CPC H01M 10/0404; H01M 50/105

(57) ABSTRACT

According to the present disclosure, provided is a manufacturing apparatus of a battery cell including an electrode assembly accommodation portion accommodating an electrode assembly, and a sealing portion sealing a perimeter of the electrode assembly accommodation portion, the sealing portion including a protrusion portion further protruding than a non-sealed surface not sealed in the electrode assembly accommodation portion, the manufacturing apparatus including: a pair of fixing blocks configured to pressurize and fix the sealing portion in a first direction, perpendicular to one surface of the sealing portion; and a folding block configured to fold the protrusion portion further protruding in a second direction, perpendicular to the first direction, further than the non-sealed surface, and the folding block may include a pressurizing portion formed to be perpendicular to the second direction, and an inclination portion extending from the pressurizing portion and forming an inclination with respect to the pressurizing portion.

### CROSS-REFERENCE TO RELATED APPLICATION(S)

This patent document claims the priority and benefits of Korean Patent Application No. 10-2024-0077689 filed on Jun. 14, 2024, the disclosure of which is incorporated herein by reference in its entirety.

### TECHNICAL FIELD

The present disclosure relates to a manufacturing apparatus of a battery cell and a manufacturing method of a battery cell.

### BACKGROUND

Secondary batteries, unlike primary batteries, may to be charged with or discharged of electricity therein or therefrom, and may be applied to devices within various fields such as digital cameras, mobile phones, laptop computers, hybrid cars, electric cars, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid square or cylindrical can-type battery cells.

A cell assembly may be disposed inside a module housing to form a battery module, and a plurality of battery modules may be disposed inside a pack housing to form a battery pack.

### SUMMARY

A pouch-type battery cell may seal at least a portion of a case during a manufacturing process, and a portion of the sealed portion may form a protrusion portion protruding further than a non-sealed surface. Such a protrusion portion may reduce the space efficiency of a battery module or a battery pack to which the battery cell is applied, or may impede the efficiency of a cooling system applied to the battery module or the battery pack.

On the other hand, when the protrusion portion is arbitrarily folded, side effects such as destruction of insulation of a case of the pouch-type battery cell or occurrence of cracks may occur.

According to an aspect of the present disclosure, the protrusion portion of the battery cell may be stably folded.

A battery cell manufactured by a manufacturing apparatus of the battery cell and a manufacturing method of the battery cell of the present disclosure may be widely applied to electric vehicles, battery charging stations, and devices within green technology fields such as solar power generation and wind power generation using other batteries. In addition, the battery cell manufactured by the present disclosure and the manufacturing method of the battery cell may be used in eco-friendly electric vehicles, hybrid vehicles, and the like, to ameliorate the effects of climate change by suppressing air pollution and greenhouse gas emissions.

A manufacturing apparatus of a battery cell according to the present disclosure including an electrode assembly accommodation portion accommodating an electrode assembly, and a sealing portion sealing a perimeter of the electrode assembly accommodation portion, the sealing portion including a protrusion portion further protruding than a non-sealed surface not sealed in the electrode assembly accommodation portion may include: a pair of fixing blocks configured to pressurize and fix the sealing portion in a first direction, perpendicular to one surface of the sealing portion; and a folding block configured to fold the protrusion portion further protruding in a second direction, perpendicular to the first direction, further than the non-sealed surface, and the folding block may include pressurizing portion formed to be perpendicular to the second direction, and an inclination portion extending from the pressurizing portion and forming an inclination with respect to the pressurizing portion.

In an embodiment, the manufacturing apparatus may further include a first driver moving the folding block in the first direction, and the folding block may be configured to be movable in the first direction by the first driver.

In an embodiment, the manufacturing apparatus may further include: a second driver moving the folding block in the second direction, and the folding block may be configured to be movable in the second direction by the second driver.

In an embodiment, the folding block moves in the first direction so that the protrusion portion is primarily folded by the inclination portion, and applies pressure to the protrusion portion in the second direction so that the protrusion is secondarily folded by the pressurizing portion.

In an embodiment, the folding block may further include a heater heating the pressurizing portion and the inclination portion.

In an embodiment, the sealing portion includes a folding line that coincides with the non-sealed surface, and one surface of the pair of fixing blocks may be disposed on the folding line.

In an embodiment, the folding block may be spaced apart from the pair of fixing blocks by a thickness of the protrusion portion.

In an embodiment, the inclination portion may be a curved surface protruding convexly toward the pair of fixing blocks.

A manufacturing method of a battery cell of the present disclosure may include an electrode assembly accommodation portion accommodating an electrode assembly, and a sealing portion sealing a perimeter of the electrode assembly accommodation portion, the sealing portion including a protrusion portion further protruding than a non-sealed surface not sealed in the electrode assembly accommodation portion may include a fixing operation of pressurizing and fixing the sealing portion in a first direction, perpendicular to one surface of the sealing portion, using a pair of fixing blocks; and a folding operation of folding the protrusion portion further protruding than the non-sealed surface in a second direction, perpendicular to the first direction, using a folding block, and in the folding operation, the folding block may include a pressurizing portion formed to be perpendicular to the second direction, and an inclination portion extending from the pressurizing portion and forming an inclination with respect to the pressurizing portion.

In an embodiment, the folding operation may include a primary folding operation of moving the inclination portion in the first direction and folding the protrusion portion using the inclination portion.

In an embodiment, the folding operation may include a secondary folding operation of moving the pressurizing portion in the second direction and applying pressure to the protrusion portion using the pressurizing portion.

In an embodiment, the folding operation is performed in a state in which at least one of the pressurizing portion and the inclination portion is heated.

In an embodiment, the manufacturing method of a battery cell may further include a cooling operation of cooling the protrusion portion by separating the folding block from the protrusion portion in the second direction.

In an embodiment, the fixing operation may fix the sealing portion so that one surface of the pair of fixing blocks is disposed on a folding line, and the folding line may be configured as a line of the sealing portion that coincides with the non-sealed surface.

According to an aspect of the present disclosure, the protrusion portion of the battery cell may be stably folded.

### BRIEF DESCRIPTION OF DRAWINGS

Certain aspects, features, and advantages of the present disclosure are illustrated by the following detailed description with reference to the accompanying drawings.

FIG. 1 is a partially perspective view illustrating a portion of a pouch-type battery cell.

FIG. 2 is a perspective view illustrating a battery cell and a manufacturing apparatus of a battery cell.

FIG. 3 is a perspective view illustrating a folding block.

FIGS. 4A to 4D are a flow chart illustrating a sequence of folding a protrusion portion using a manufacturing apparatus of the battery cell according to the present disclosure.

FIG. 5 is a perspective view illustrating a modified example of a folding block.

FIG. 6 is a flow chart illustrating a manufacturing method of a battery cell according to the present disclosure.

### DETAILED DESCRIPTION

Prior to describing the exemplary embodiments in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation. Therefore, it should be understood that the embodiments described in this specification and the configurations illustrated in the drawings are only the most desirable embodiments of the disclosed technology and do not represent all the technical concepts of disclosed technology, and accordingly, there may be various equivalents and variations that can replace the embodiments and the configurations of the disclosed technology at the time of this application.

Hereinafter, with reference to the drawings, specific embodiments of the present disclosure will be described. In this case, it should be noted that in the attached drawings, identical components are indicated by identical symbols whenever possible. Additionally, detailed descriptions of well-known functions and configurations that may obscure the gist of the present disclosure will be omitted. For the same reason, some components are exaggerated, omitted, or schematically depicted in the accompanying drawings, and the size of each component does not entirely reflect its actual size. For example, in this specification, the expressions such as “above,” “upper,” “upward,” “below”, “beneath,” “lower,” “downward,” “side,” and the like, are based on the direction illustrated in the drawings, and may be expressed differently if the direction of the object is changed.

Hereinafter, a manufacturing apparatus of a battery cell and a manufacturing method of a battery cell according to the present disclosure will be specifically described with reference to drawings.

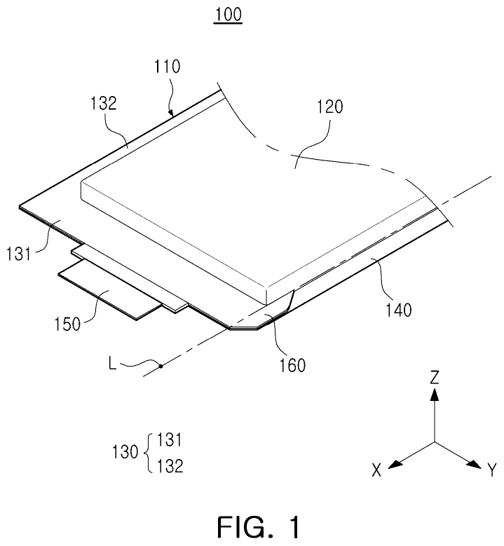

FIG. 1 is a partially perspective view illustrating a portion of a pouch-type battery cell 100.

A manufacturing apparatus of a battery cell 100 according to the present disclosure including an electrode assembly accommodation portion 120 accommodating an electrode assembly, and a sealing portion 130 sealing a perimeter of the electrode assembly accommodation portion 120, the sealing portion 130 including a protrusion portion 160 further protruding than a non-sealed surface 140 not sealed in the electrode assembly accommodation portion may include: a pair of fixing blocks 200 configured to pressurize and fix the sealing portion 130 in a first direction, perpendicular to one surface of the sealing portion 130; and a folding block 300 configured to fold the protrusion portion 160 further protruding in a second direction, perpendicular to the first direction, further than the non-sealed surface 140, and the folding block 300 may include a pressurizing portion 310 formed to be perpendicular to the second direction, and an inclination portion 320 extending from the pressurizing portion and forming an inclination with respect to the pressurizing portion 310.

Referring to FIG. 1, the battery cell 100 may include a case 110, an electrode assembly accommodation portion 120, a sealing portion 130, a non-sealed surface 140, an electrode tab 150, a protrusion portion 160, and a folding line L.

The case 110 may be a pouch-type case formed of a flexible material. The pouch-type case 110 used for the battery cell 100 may be manufactured from various flexible materials or composites of various materials. For example, the pouch-type case 110 may be formed of a triple composite film of nylon, an aluminum foil, and casting polypropylene.

This is only one example of a material of the pouch-type case 110 and is not necessarily limited thereto. The pouch-type case 110 may be formed of a flexible material and may be formed into an outer shape required for the battery cell 100 by forming. For example, one surface of the pouch-type case 110 may be formed into a square. However, the square is only one example and the pouch-type case 110 does not necessarily have to be formed into a square and may be formed into various shapes.

The electrode assembly accommodation portion 120 may be formed in the case 110 and may be a space accommodating an electrode assembly and an electrolyte. The electrode assembly may include an electrode plate and a separator. The electrode plate may include a cathode plate and an anode plate. The separator may be formed of an insulator interposed between the anode plate and the cathode plate. The electrode assembly may be configured as a stack type in which the anode plate, the cathode plate and the separator are alternately stacked, or as a jelly roll type in which the anode plate, the cathode plate and the separator stacked are wound together. Each of the anode plate and the cathode plate may have a structure in which an anode active material or a cathode active material is coated on a foil. For example, the anode plate may be formed by coating graphite or the like on a foil formed of a copper or nickel material, and the cathode plate may be formed by coating a transition metal oxide active material on a foil formed of an aluminum material.

The sealing portion 130 may be a portion sealing a perimeter of the electrode assembly accommodation portion 120. The sealing referred to here may be sealing the electrode assembly accommodation portion 120 by heat-melting a portion of a case 110 formed of a flexible material.

The non-sealed surface 140 may be one surface not sealed in the electrode assembly accommodation portion 120. At least one surface of the pouch-type battery cell 100 may not be sealed. For example, three surfaces except one surface of four side surfaces of the electrode assembly accommodation portion may be sealed to form a sealing portion 130, and the one surface may be not sealed.

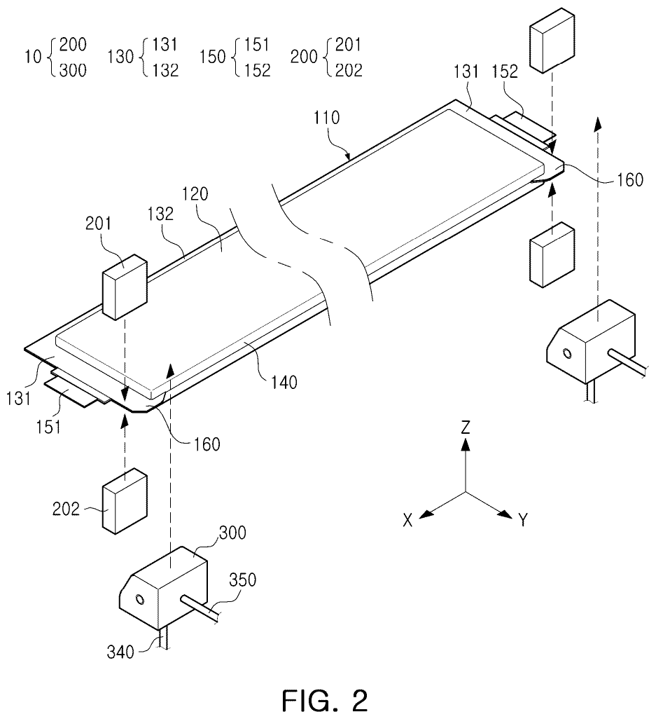

The electrode tab 150 may be a component for electrically connecting a plurality of cathode plates or a plurality of anode plates of the electrode assembly. Referring first to FIG. 2, the electrode tab 150 may include an anode tab 151 and a cathode tab 152. For example, the anode plate may be a component electrically connected to a plurality of anode plates, and the cathode tab 152 may be a component electrically connected to a plurality of cathode plates. The cathode tap 152 and the anode tap 151 may be disposed on a side surface of the case 110 and may be disposed to be oriented in one direction or different directions. For example, the battery cell 100 in which the cathode tap 152 and the anode tap 151 are disposed to be oriented in the same direction may be referred to as a unidirectional battery cell 100, and the battery cell 100 in which the cathode tap 152 and the anode tap 151 are disposed to be oriented in different directions may be referred to as a bidirectional battery cell 100. Although the battery cell 100 illustrated in the drawings of this specification is illustrated as the bidirectional battery cell 100, the battery cell 100 of the present disclosure is not necessarily limited thereto and may also be applied to the unidirectional battery cell 100.

The sealing portion 130 may include a first sealing portion 131 and a second sealing portion 132. The second sealing portion 132 may be a sealing portion 130 disposed opposite the non-sealed surface 140. The first sealing portion 131 may be a sealing portion 130 disposed on both sides of the non-sealing surface 140. For example, the sealing portion 130 on which the electrode tab 150 is disposed may be the first sealing portion 131. The first sealing portion 131 may be a portion sealed by including the electrode tab 150 so that the electrode tab 150 protrudes toward the outside of the case 110.

The protrusion portion 160 and may be a portion included in the sealing portion 130 and protruding in a second direction (Y-axis), perpendicular to the first direction (Z-axis), among the sealing portions 130. Here, the first direction (Z-axis) may be a direction, perpendicular to one surface of the sealing portion 130. Specifically, the protrusion portion 160 may be a portion of the sealing portion 130 further protruding than the non-sealed surface 140 in the second direction (Y-axis).

The folding line L may be formed on the sealing portion 130 and may be a line that coincides with the non-sealed surface 140. For example, the folding line L may be a straight line formed so that a virtual surface extending along the non-sealed surface 140 and the sealing portion 130 are consistent with each other. The folding line L may be a virtual line or a physical line indicated on the sealing portion 130. When the folding line L is formed as a physical line, the folding line L may be a line drawn on the sealing portion 130 or a groove formed by pressurization. The folding line L may be a reference for folding the protrusion portion 160. For example, the folded portion of the protrusion portion 160 may coincide with the folding line L.

FIG. 2 is a perspective view illustrating a battery cell 100 and a manufacturing apparatus of a battery cell 10.

Referring to FIG. 2, the manufacturing apparatus of a battery cell 10 may include a pair of fixing blocks 200 and a folding block 300.

The battery cell 100 may include an electrode assembly accommodation portion 120 accommodating an electrode assembly, and a sealing portion 130 sealing a perimeter of the electrode assembly accommodation portion 120, and the sealing portion 130 may be a battery cell 100 including a protrusion portion 160 further protruding than the non-sealed surface 140 not sealed in the electrode assembly accommodation portion 120.

The pair of fixing blocks 200 may be configured to fix the sealing portion 130 by applying pressure in the first direction (Z-axis). For example, the pair of fixing blocks 200 may be disposed one by one on both sides based on the sealing portion 130. The pair of fixing blocks 200 may be formed by a first fixing block 201 disposed above the sealing portion 130 and a second fixing block 202 disposed below the sealing portion 130. The fixing blocks 200 may be formed in a pair and may move in the first direction (Z-axis), perpendicular to the sealing portion 130. Accordingly, the pair of fixing blocks 200 may pressurize and fix the sealing portion 130 in the first direction (Z-axis). A shape of the fixing block 200 may be variously formed. For example, the fixing block 200 may be formed to have a rectangular solid. However, the shape thereof is only one example, and any shape that may stably fix the sealing portion 130 in a process of folding the protrusion portion 160 may be used.

The folding block 300 may be configured to fold the protrusion portion 160. The folding block 300 may move in the first direction (Z-axis) or the second direction (Y-axis) and may fold the protrusion portion 160. The manufacturing apparatus of a battery cell 10 may include a first driver 340 moving the folding block 300 in the first direction (Z-axis), and may include a second driver 350 moving the folding block 300 in the second direction (Y-axis). The folding block 300 may be configured to be movable in the first direction (Z-axis) by the first driver 340. In addition, the folding block 300 may be configured to be movable in the second direction (Y-axis) by the second driver 350. For example, the first driver 340 may be a shaft which is coupled to one surface of the folding block 300 and which is movable in the first direction (Z-axis). Similarly, the second driver 350 may also be a shaft which is coupled to one surface of the folding block 300 and which is moveable in the second direction (Y-axis).

The pair of fixing blocks 200 and folding blocks 300 may be disposed on both sides of the battery cell 100. For example, the first sealing portion 131 and the protrusion portion 160 may be formed on both sides in a direction in which the electrode tab 150 is disposed based on the electrode assembly accommodation portion 120. The pair of fixing blocks 200 and folding blocks 300 may also be disposed together on both sides on which the first sealing portion 131 and the protrusion portion 160 are disposed.

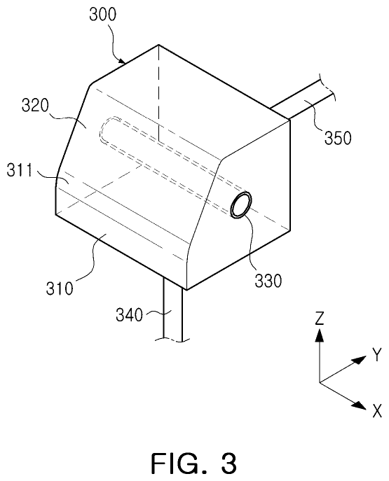

FIG. 3 is a perspective view illustrating a folding block 300.

Referring to FIG. 3, the folding block 300 may include a pressurizing portion 310, an inclination portion 320 and a heater 330. The folding block 300 moves in the first direction so that the protrusion portion 160 is primarily folded by the inclination portion 320, and applies pressure to the protrusion portion 160 in the second direction so that the protrusion is secondarily folded by the pressurizing portion 310.

The pressurizing portion 310 may include a pressurizing portion 310 formed to be perpendicular to the second direction (Y-axis). For example, the pressurizing portion 310 may include a surface applying pressure to a protrusion portion 160 to be described below, and may be disposed in a direction oriented toward the protrusion portion 160, among the second directions (Y-axis) of the folding block 300. One surface of the pressurizing portion 310 formed to be perpendicular to the second direction (Y-axis) may be configured as a plane. Accordingly, the same force may be applied to a front surface of the protrusion portion 160.

The inclination portion 320 may extend from the pressurizing portion 310. For example, the inclination portion 320 may extend from an upper end of the pressurizing portion 310, perpendicular to the second direction (Y-axis) of the pressurizing portion 310. In this case, the inclination portion 320 may begin to extend, and a boundary portion 311 in contact with the pressurizing portion 310 may be formed to be round. Since the protrusion portion 160 passes through the boundary portion 311 during the folding process described below, the boundary portion 311 may be formed to be round in order to reduce damage to the protrusion portion 160. The inclination portion 320 may be inclined with respect to the pressurizing portion 310. For example, the inclination portion 320 may be inclined so as to form a certain angle rather than being on the same line as a vertical pressurizing portion 310. Specifically, the inclination portion 320 may be inclined so as to be far away from the protrusion portion 160 as the inclination portion 320 moves up in the first direction (Z-axis) starting from the boundary portion 311.

The heater 330 may be further included in the folding block 300. For example, the heater 330 may be in the form of a cylinder formed to penetrate through a side surface of the folding block 300. However, this is only one example of the shape of the heater 330 and the present disclosure is not necessarily limited thereto. The heater 330 may heat the pressurizing portion 310 and the inclination portion 320. For example, the heater 330 may be disposed inside the folding block and may be disposed close to the pressurizing portion 310 and the inclination portion 320. The heater 330 may heat itself and may heat the entire folding block 300. In this case, the heater 330 may transfer heat to the pressurizing portion 310 and the inclination portion 320 to increase the temperature of the pressurizing portion 310 and the inclination portion 320.

The folding block 300 may be coupled with the first driver 340 and the second driver 350. For example, the first driver 340 may be coupled to one surface formed in the first direction (Z-axis) of the folding block 300, and the second driver 350 may be coupled to one surface formed in the second direction (Y-axis) of the folding block 300. The first driver 340 and the second driver 350 may be coupled to a surface on which the pressurizing portion 310 and the inclination portion 320 are not disposed, among one surface of the folding block 300.

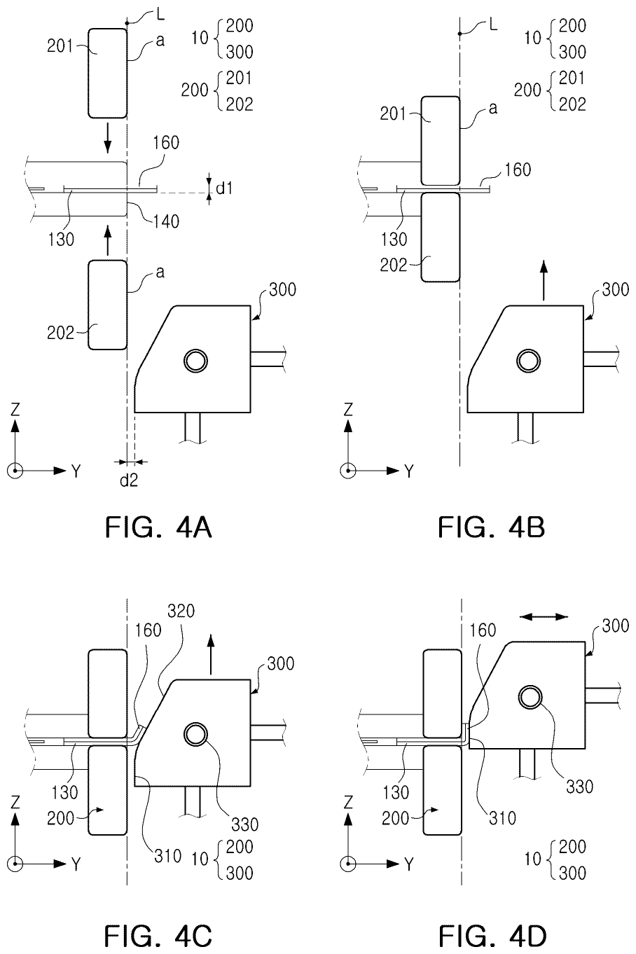

FIGS. 4A to 4D are a flowchart illustrating a sequence of folding a protrusion portion 160 using a manufacturing apparatus of a battery cell 10 according to the present disclosure.

Referring to FIGS. 4A to 4D, a method of folding the protrusion portion 160 may be understood using the manufacturing apparatus of a battery cell 10.

FIG. 4A illustrates a state before the pair of fixing blocks 200 fix the sealing portion 130. One surface (a) of the pair of fixing blocks 200 may be disposed on the folding line L. For example, one surface of the pair of fixing blocks 200 in the second direction (Y-axis) may disposed on the folding line L, and the remaining portion of the fixing block 200 may be disposed on the sealing portion 130 not including the protrusion portion 160, based on the folding line L. The pair of fixing blocks 200 may move in the first direction (Z-axis). A folding block 300 may be spaced apart from the pair of fixing blocks 200 by a thickness of the protrusion portion 160. For example, the folding block 300 may be spaced apart from the fixing block 200 based on the pressurizing portion 310 of the folding block 300 and the folding line L, and in this case, the spaced interval may be a thickness of the protrusion portion 160 or the sealing portion 130. Since the folding block 300 moves in the first direction (Z-axis) and folds the protrusion portion 160, the folding block 300 may be spaced apart from the fixing block 200 in considering of the thickness of the protrusion portion 160.

FIG. 4B illustrates a state in which the pair of fixing blocks 200 fix the sealing portion 130. The pair of fixing blocks 200 may move in the first direction (Z-axis) based on the sealing portion 130 and may pressurize and fix the sealing portion 130. For example, the first fixing block 201 and the second fixing block 202 may be disposed to face each other and may move in the first direction (Z-axis) so as to become closer. In this case, one surface (a) of the pair of fixing blocks 200 may be maintained to coincide with the folding line L. The pair of fixing blocks 200 may be fixed by applying pressure thereto in a state of contacting the sealing portion 130. In this case, pressurizing force may be set to a degree that the sealing portion 130 is not damaged and the protrusion portion 160 is folded.

FIG. 4C illustrates a state in which the folding block 300 moves in the first direction (Z-axis) and primarily folding the protrusion portion 160 toward the inclination portion 320. The folding block 300 may move in the first direction (Z-axis), and the inclination portion 320 may move and may be in contact with the protrusion portion 160. The protrusion portion 160 may be in contact with the inclination portion 320 and may be folded along the inclination portion 320 toward the sealing portion 130. In this case, the inclination portion 320 may be in a state of applying pressure thereto by the heater 330. Accordingly, thermal deformation of the protrusion portion 160 may be induced to easily perform the folding. The folding block 300 may move in the first direction (Z-axis) until the pressurizing portion 310 reaches a position of the protrusion portion 160.

FIG. 4D illustrates the folding of the protrusion portion 160 by moving the folding block 300 in the second direction (Y-axis). When the primary folding is completed, the protrusion portion 160 is in contact with the pressurizing portion 310 and may be folded to be perpendicular to the sealing portion 130. In this case, the protrusion portion 160 may need to be pressurized and heated so as to maintain a folded shape. The folding block 300 may pressurize the protrusion portion 160 using the pressurizing portion 310. For example, the folding block 300 may move in the second direction (Y-axis) to pressurize the protrusion portion 160. While the pressurizing portion 310 presses, the fixing block 200 may be disposed on an opposite side of the folding block 300 with respect to the protrusion portion 160. Accordingly, the fixing block 200 may play a supporting role so that the pressurizing portion 310 may pressurize the protrusion portion 160. In this case, the pressurizing portion 310 may be heated by the heater 330, and may induce thermal deformation of the protrusion portion 160.

After the secondary folding is completed, the folding block 300 may return to the position of FIG. 4A. In this case, the protrusion portion 160 may move away from the heated folding block 300 and may be cooled to maintain a thermally deformed state. Although not illustrated in the drawing, the fixing block 200 fixing the sealing portion 130 may also return to an original position thereof.

When stress such as excessive force or high temperature is applied during the folding process of the protrusion portion 160, the protrusion portion 160 may be damaged and at least a portion thereof may be destroyed. In this case, adverse effects such as destruction of the insulation of the case 110 or occurrence of cracks may be caused. According to the manufacturing apparatus of a battery cell 10 according to the present disclosure, the protrusion portion 160 may be stably folded through the primary and secondary folding processes by the inclination portion 320 and the pressurizing portion 310.

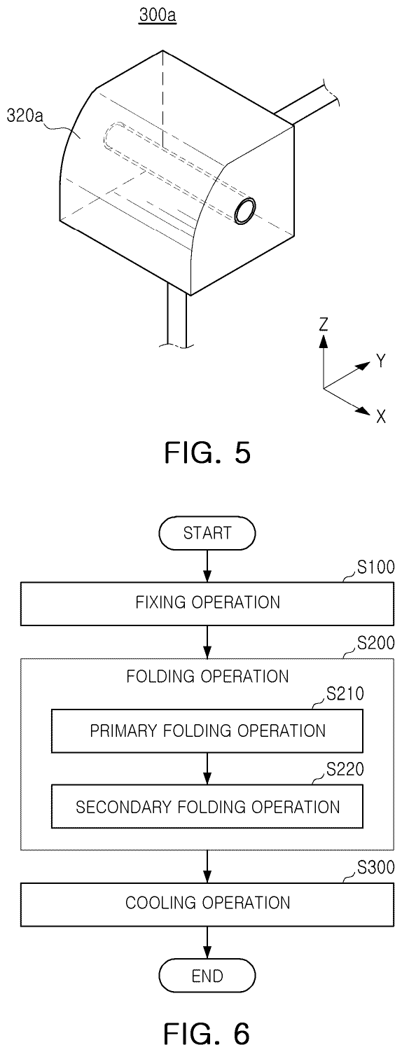

FIG. 5 is a perspective view illustrating a modified example of the folding block.

Referring to FIG. 5, an inclination portion 320a may include a curved surface. For example, the inclined portion 320a may be a curved surface protruding convexly toward a pair of fixing blocks 200. Specifically, the inclination portion 320a may protrude outwardly from a folding block 300a, and may be formed as a curved surface in this time. When the inclination portion 320a is formed as a curved surface, the speed at which the protrusion portion 160 is folded during a primary folding process may be controlled. Accordingly, the shape of the curved surface may be variously formed as needed.

FIG. 6 is a flow chart illustrating a manufacturing method of a battery cell 100 according to the present disclosure.

Referring to FIG. 6 and FIGS. 1 to 5 together, in the manufacturing method of a battery cell 100 of the present disclosure, the battery cell 100 including an electrode assembly accommodation portion 120 accommodating an electrode assembly, and a sealing portion 130 sealing a perimeter of the electrode assembly accommodation portion 120, and the sealing portion 130 may include a protrusion portion 160 further protruding than an non-sealed surface 140 not sealed in the electrode assembly accommodation portion 120. And the manufacturing method of a battery cell 100 may include a fixing operation (S100) of pressurizing and fixing the sealing portion 130 in a first direction, perpendicular to one surface of the sealing portion 130, using a pair of fixing blocks 200; and a folding operation (S200) of folding the protrusion portion 160 further protruding than the non-sealed surface 140 in a second direction, perpendicular to the first direction, using a folding block 300, and in the folding operation (S200), the folding block 300 may include a pressurizing portion formed to be perpendicular to the second direction, and an inclination portion 320 extending from the pressurizing portion and forming an inclination with respect to the pressurizing portion 310.

The manufacturing method of a battery cell 100 may include a fixing operation (S100) and a folding operation (S200).

The fixing operation (S100) may be an operation of fixing the sealing portion 130 by applying pressure thereof in the first direction (Z-axis), perpendicular to one surface of the sealing portion 130 using a pair of fixing blocks 200. This process is illustrated in FIGS. 4A and 4B. The pair of fixing blocks 200 may be moved in the first direction (Z-axis) to pressurize and fix the sealing portion 130. Specifically, the sealing portion 130 may be fixed so that one surface (a) of the pair of fixing blocks 200 is disposed on the folding line L. The folding line L may be configured as a line that coincides with the non-sealed surface 140 in the sealing portion 130. Accordingly, in the process of folding the protrusion portion 160 by the folding block 300 described below, the sealing portion 130 and the protrusion portion 160 may be maintained in a fixed state, and the protrusion portion 160 may be folded along the folding line L.

The folding operation (S200) may be an operation of folding the protrusion portion 160 protruding in the second direction (Y-axis), perpendicular to the first direction (Z-axis), from the non-sealing surface 140 using the folding block 300. This process is illustrated in FIGS. 4C and 4D. The folding block 300 may include a pressurizing portion 310 and an inclination portion 320.

The folding operation (S200) may include a primary folding operation (S210) and a secondary folding operation (S220).

The primary folding operation (S210) may be an operation of moving the inclination portion 320 in the first direction (Z-axis) and folding the protrusion portion 160 using the inclination portion 320. For example, the folding block 300 may move in the first direction (Z-axis) by the first driver 340. The inclination portion 320 may move in the first direction (Z-axis) and may fold the protrusion portion 160.

The secondary folding operation may be an operation of moving the pressurizing portion 310 in the second direction (Y-axis) and applying pressure to the protrusion portion 160 using the pressurizing portion 310. For example, the folding block 300 may move in the second direction (Y-axis) by the second driver 350. The pressurizing portion 310 may move in the second direction (Y-axis) and may fold the protrusion portion 160.

The folding operation (S200) may be performed in a state of heating at least one of the pressurizing portion 310 and the inclination portion 320. For example, the inclination portion 320 may be heated by the heater 330 disposed inside the folding block 300. Accordingly, the heated inclination portion 320 may fold the protrusion portion 160, and induce thermal deformation. may Additionally, the pressurizing portion 310 may also be heated by the heater 330. Accordingly, the heated pressurizing portion 310 may vertically apply pressure to the protrusion portion 160 to induce thermal deformation.

The manufacturing method of a battery cell 100 may further include a cooling operation (S300).

The cooling operation (S300) may be an operation of cooling the protrusion portion 160. For example, the folding block 300 may be spaced apart from the protrusion portion 160 in the second direction (Y-axis) and then cooled. Specifically, the heated folding block 300 may be spaced apart from the protrusion portion 160 to induce cooling with air at room temperature. Although not illustrated in the drawing, an additional device for cooling may also be added.

Although embodiments of the present disclosure have been described above, the scope of the present disclosure is not limited thereto, and it will be apparent to those skilled in the art that modifications and variations could be made without departing from the scope of the technical concept of the present disclosure as defined by the appended claims.

What is claimed is:

1. A manufacturing apparatus of a battery cell comprising an electrode assembly accommodation portion accommodating an electrode assembly, and a sealing portion sealing a perimeter of the electrode assembly accommodation portion, the sealing portion including a protrusion portion further protruding than a non-sealed surface not sealed in the electrode assembly accommodation portion, the manufacturing apparatus comprising:
a pair of fixing blocks configured to pressurize and fix the sealing portion in a first direction, perpendicular to one surface of the sealing portion; and
a folding block configured to fold the protrusion portion further protruding in a second direction, perpendicular to the first direction, further than the non-sealed surface,
wherein the folding block includes a pressurizing portion formed to be perpendicular to the second direction, and an inclination portion extending from the pressurizing portion and forming an inclination with respect to the pressurizing portion.

2. The manufacturing apparatus of a battery cell of claim 1, further comprising:
a first driver moving the folding block in the first direction,
wherein the folding block is configured to be movable in the first direction by the first driver.

3. The manufacturing apparatus of a battery cell of claim 2, further comprising:
a second driver moving the folding block in the second direction,
wherein the folding block is configured to be movable in the second direction by the second driver.

4. The manufacturing apparatus of a battery cell of claim 3, wherein the folding block moves in the first direction so that the protrusion portion is primarily folded by the inclination portion, and applies pressure to the protrusion portion in the second direction so that the protrusion is secondarily folded by the pressurizing portion.

5. The manufacturing apparatus of a battery cell of claim 1, wherein the folding block further includes a heater heating the pressurizing portion and the inclination portion.

6. The manufacturing apparatus of a battery cell of claim 1, wherein the sealing portion includes a folding line that coincides with the non-sealed surface, and
one surface of the pair of fixing blocks is disposed on the folding line.

7. The manufacturing apparatus of a battery cell of claim 6, wherein the folding block is spaced apart from the pair of fixing blocks by a thickness of the protrusion portion.

8. The manufacturing apparatus of a battery cell of claim 1, wherein the inclination portion is a curved surface protruding convexly toward the pair of fixing blocks.

9. A manufacturing method of a battery cell comprising an electrode assembly accommodation portion accommodating an electrode assembly, and a sealing portion sealing a perimeter of the electrode assembly accommodation portion, the sealing portion including a protrusion portion further protruding than a non-sealed surface not sealed in the electrode assembly accommodation portion, the manufacturing method comprising:
a fixing operation of pressurizing and fixing the sealing portion in a first direction, perpendicular to one surface of the sealing portion, using a pair of fixing blocks; and
a folding operation of folding the protrusion portion further protruding than the non-sealed surface in a second direction, perpendicular to the first direction, using a folding block,
wherein in the folding operation, the folding block includes a pressurizing portion formed to be perpendicular to the second direction, and an inclination portion extending from the pressurizing portion and forming an inclination with respect to the pressurizing portion.

10. The manufacturing method of a battery cell of claim 9, wherein the folding operation includes a primary folding operation of moving the inclination portion in the first direction and folding the protrusion portion using the inclination portion.

11. The manufacturing method of a battery cell of claim 10, wherein the folding operation includes a secondary folding operation of moving the pressurizing portion in the second direction and applying pressure to the protrusion portion using the pressurizing portion.

12. The manufacturing method of a battery cell of claim 11, wherein the folding operation is performed in a state in which at least one of the pressurizing portion and the inclination portion is heated.

13. The manufacturing method of a battery cell of claim 12, further comprising:
a cooling operation of cooling the protrusion portion by separating the folding block from the protrusion portion in the second direction.

14. The manufacturing method of a battery cell of claim 9, wherein the fixing operation fixes the sealing portion so that one surface of the pair of fixing blocks is disposed on a folding line, and
the folding line is configured as a line of the sealing portion that coincides with the non-sealed surface.
